(19) United States
(12) Patent Application Publication
(10) Pub. No.: US 2013/0205828 A1
(43) Pub. Date: Aug. 15, 2013

(54) INTEGRATION OF A LIQUEFIED NATURAL GAS LIQUEFIER WITH THE PRODUCTION OF LIQUEFIED NATURAL GAS

(71) Applicants: Rustam H. Sethna, Clinton, NJ (US); Richard Potthoff, Scotch Plains, NJ (US); Guillaume Pages, Huningue (FR)

(72) Inventors: Rustam H. Sethna, Clinton, NJ (US); Richard Potthoff, Scotch Plains, NJ (US); Guillaume Pages, Huningue (FR)

(21) Appl. No.: 13/626,133

(22) Filed: Sep. 25, 2012

Related U.S. Application Data
(60) Provisional application No. 61/543,863, filed on Oct. 6, 2011.

(51) Int. Cl. B01D 53/047

(52) U.S. Cl. CPC B01D 53/047
USPC 62/607; 95/96; 95/98; 95/97

(57) ABSTRACT

A method for integrating a liquefied natural gas liquefier system with production of liquefied natural gas from a methane-containing gas stream. The liquefied natural gas is produced by feeding a methane-containing gas stream through a heat exchanger to a distillation column and liquefying the natural gas while capturing the gaseous nitrogen. The liquefied natural gas is captured and the nitrogen gas is recovered, fed through the heat exchanger to recover cold and purified.

### CROSS REFERENCE TO RELATED APPLICATIONS

This application claims priority from U.S. Provisional Patent Application Ser. No. 61/543,863 filed Oct. 6, 2011.

### BACKGROUND OF THE INVENTION

The invention is the integration of a liquefied natural gas (LNG) liquefier system with the production of LNG from biogas or landfill gas.

Production of alternative fuels from low-grade methane opportunity sources, such as biogas and landfill gas, is challenging but has great value. Alternative fuels derived from such sources include liquefied natural gas, liquid to compressed natural gas (LCNG), small-scale hydrogen production form low-grade natural gas and pipeline injection of compressed, purified natural gas. The primary natural gas sources of interest are landfill gas and biogas, particularly digester gas, wastewater treatment off-gas, coal seam methane as well as other opportunistic biogas sources.

Renewable methane can be recovered from a number of sources, such as anaerobic digestion of municipal or industrial waste streams, the degradation of biomass in landfills, the gasification of waste and biomass streams, amongst others. In many instances, this renewable methane require purification before it can be used and/or sold into higher valued markets, such as injection into the pipeline grid, as a feedstock for liquefied natural gas, as a vehicle fuel, or as a feedstock for the production of hydrogen. Further, the energy that is required to purify the renewable methane is significant.

The cleanup of biogas/landfill gas is both capital and power intensive because it contains a large number of trace and bulk contaminants in fairly large concentrations. Various methods are employed to remove these including chilling, cryogenic methods and various adsorption and scrubbing processes. However, these processes can be expensive in both capital and operating costs and it is important to minimize these costs to achieve an economically viable process.

A typical process for the purification of the methane from biogas/landfill gas requires several steps. Sulfur removal is generally followed by drying by removing water. The dried gas stream is then treated for contaminants such a volatile organic compounds by processes such as adsorption, CO₂ washing or by cryogenic methods. The stream is then treated for bulk carbon dioxide removal by a membrane or adsorption process and then is treated for removal of nitrogen. All these purification steps are necessary before the biogas/landfill gas can be liquefied and stored in anticipation of being dispensed, or directed towards other uses, such as pipeline injection, energy production with fuel cells or small-scale hydrogen production. LNG production is particularly challenging since all condensable contaminants including carbon dioxide must be removed to low ppm levels.

Inert compounds which can include non-condensable compounds such as hydrogen may be found in landfill gas and other sources of methane. The presence of these compounds makes traditional liquefaction techniques without their removal more difficult and will increase the power costs of the liquefaction process. The inventive method provides advantages over other systems such as molecular gate and vacuum swing adsorption systems when hydrogen is present. Molecular gate and vacuum swing adsorption processes do not remove hydrogen so liquefaction systems that depend on these methods for the removal of inert compounds will have additional concerns over increased power consumption.

### SUMMARY OF THE INVENTION

The invention provides for using purified landfill or biogas to make combinations of liquefied natural gas, liquid to compressed natural gas, renewable hydrogen or renewable natural gas for pipeline injection. A liquefier is integrated with a thermosyphon reboiler distillation column, which may be a packed column, for inert gas such as nitrogen removal for small-scale liquefied biogas production. Additionally, excess oxygen may be removed from a methane rich stream.

The invention may be employed in a variety of liquefaction methods including but not limited to cascade cycles, single stage mixed refrigerant cycles with and without propane/ammonia pre-cooling, multi-stage mixed refrigerant cycles and nitrogen cycles with and without expanders.

In one embodiment of the invention, there is disclosed a method for purifying a methane-containing gas comprising the steps of:

a) feeding a feedstream of methane-containing gas to a first pressure swing adsorption unit to remove contaminants from the biogas or landfill gas;
b) feeding the methane-containing gas to a guard bed wherein further contaminants are removed from the methane-containing gas;
c) feeding the methane-containing gas to a temperature swing adsorption unit to remove carbon dioxide; and
d) recovering purified biogas or landfill gas.

In a further embodiment of the invention, there is disclosed a method for purifying a methane-containing gas comprising the steps of:

a) feeding a feedstream of methane-containing gas to a first pressure swing adsorption unit to remove contaminants from the methane-containing gas;
b) feeding the methane-containing gas to a guard bed wherein further contaminants are removed from the methane-containing gas;
c) feeding the methane-containing gas to a second pressure swing adsorption unit to remove carbon dioxide; and
d) recovering purified methane-containing gas.

The methane-containing gas is typically biogas or landfill gas but may be other gas mixtures that are predominantly methane in content. The methane-containing gas may be compressed and fed to a separator to remove condensates and particles prior to entering the first pressure swing adsorption unit. The contaminants that are typically removed by the first pressure swing adsorption unit are selected from the group consisting of hydrogen sulfide, water, non-methane organic compounds (NMOCs) and carbon dioxide. The first pressure swing adsorption unit will contain adsorbents to remove these contaminants. The contaminants that are separated out in the first pressure swing adsorption unit will be destroyed in a thermal oxidizer.

The methane-containing gas recovered from the first pressure swing adsorption unit is fed to a guard bed but a portion may be diverted back to the line feeding the methane-containing into the first pressure swing adsorption unit or the feed line entering the thermal oxidizer.

The guard bed will remove trace contaminants selected from the group consisting of halogenated compounds such as vinyl chloride; volatile sulfur compounds such as carbonyl sulfide (COS) carbon disulfide and mercaptans; volatile oxygenates such as dimethyl ether, alcohols and ketones; aromatic hydrocarbon containing compounds such as benzene; volatile hydrocarbons such as hexanes, pentanes, butane, etc.; siloxanes and mercury from the methane-containing gas. Carbon dioxide that is separated out in the various separation processes may be employed to purge the adsorbent beds in the first pressure swing adsorption unit. Nitrogen from the distillation column may be used to purge the adsorbent beds in the temperature swing adsorption unit. This nitrogen may be heated by vent gas from the thermal oxidizer prior to it entering the temperature swing adsorption unit.

In the embodiment that employs a first and a second pressure swing adsorption unit, carbon dioxide from the second pressure swing adsorption unit may be used to purge the adsorbent beds in the first pressure swing adsorption unit. The nitrogen from the distillation column may be used to purge the adsorbent beds in the second pressure swing adsorption unit.

In a further embodiment of the invention, there is disclosed a method for producing liquefied natural gas comprising the steps of:

a) feeding a methane-containing gas stream selected from the group consisting of biogas and landfill gas to a heat exchanger, wherein the methane-containing gas stream will be cooled by the heat exchanger;
b) feeding the methane-containing gas to the reboiler of a distillation column, wherein the distillation column can be packed or contain sieve trays;
c) removing methane from the bottom of the packed distillation column as liquefied natural gas;
d) collecting nitrogen from the top of the packed distillation column and feeding the nitrogen through the heat exchanger and recovering cold;
e) purifying the nitrogen; and
f) feeding said purified nitrogen through said heat exchanger.

In typical operation, purified natural gas containing mainly methane, nitrogen and small amounts of oxygen at between 6 and 15 bar from a landfill or other source of methane-containing gas is fed to the top of a main heat exchanger and cooled down to about −145° C. The cooled down natural gas is fed to the reboiler part of a distillation column where it will exchange heat with product liquefied natural gas present in the reboiler and lowering its temperature to about −155° C. This methane is then fed via a Joule-Thomsen valve to the top of the packed distillation column where the reboiler resides. Typically the packed distillation column does not have a condenser. The nitrogen rich gas will rise to the top of the packed distillation column while the methane rich liquid is removed from the bottom.

The nitrogen-rich gas waste gas stream from the top of the column is directed to the main heat exchanger where its cold is recovered before being fed to a cleanup system for purifying the nitrogen gas. The product liquefied natural gas is pumped from the bottom of the packed distillation column to vacuum-insulated tanks kept at between 1 and 5 barg. A cryogenic pump is used to transport the liquefied natural gas to the storage tanks. The purified liquefied natural gas is then available as a fuel for example for heavy-duty trucks, refuse vehicles, buses and other fleet vehicles.

This integration of the separation systems allows the overall system great efficiency by lowering net power consumption over typical pressure swing adsorption nitrogen recovery units. The integration eliminates the need for a vacuum pump and recycle compressors which are also typical of pressure swing adsorption nitrogen recovery units thus lowering capital cost for plant construction. Indeed, the invention may have applicability to other methane sources such as bio-digesters and other opportunistic sources of methane.

### BRIEF DESCRIPTION OF THE DRAWINGS

FIG. 1a is a schematic of an integrated biogas/landfill gas purification system.

FIG. 1b is a schematic of an integrated biogas/landfill gas purification system.

FIG. 2 is a schematic of an integrated mixed refrigerant liquefied natural gas liquefier with a reboiler column for nitrogen removal.

FIG. 3 is a schematic of an integrated mixed refrigerant liquefied natural gas liquefier with a reboiler column for nitrogen removal.

FIG. 4 is a schematic of a packed distillation column as used in the invention.

### DETAILED DESCRIPTION OF THE INVENTION

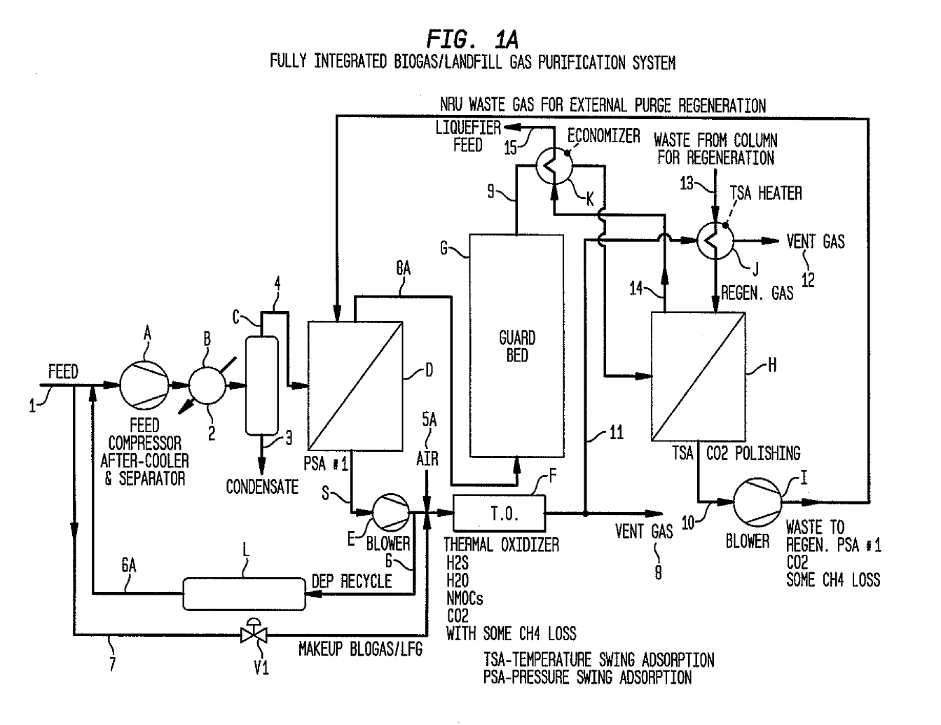

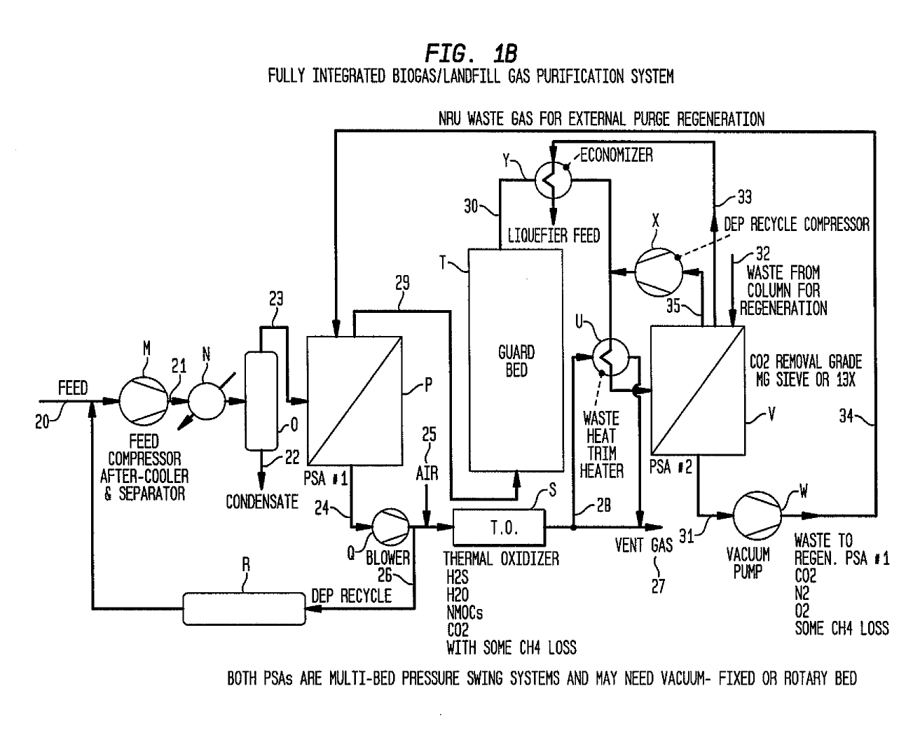

FIG. 1a is a schematic of a fully integrated biogas/landfill gas purification system according to the invention. Line 1 feeds a biogas or liquefied fuel gas into a feed compressor A which will pressurize the feed gas for entry into the purification system. The compressed feed gas will enter an after-cooler B through line 2 and be fed to a separator C where liquid condensate will be separated from the feed gas stream through line 3 as well as heavier volatile organic compounds (VOCs), dust and other particles. The feed gas stream will leave the separator C through line 4 and be fed to the first pressure swing adsorption unit D.

The feed gas stream will be separated in the first pressure swing adsorption unit D into a methane gas stream and a stream containing by-products such as hydrogen sulfide, water, carbon dioxide NMOCs and some methane. The pressure swing adsorption unit D contains an adsorbent or adsorbents capable of separating methane from the impurities present in the biogas/landfill feed gas. These may be molecular sieves, Clinoptolites and aluminas which may be mixed or layered into individual beds. The by-product gas stream will be fed through line 5 to a blower E to a thermal oxidizer F. Air may be inputted into line 5 through line 54A prior to entry into the thermal oxidizer F. Makeup biogas or landfill gas through line 1 may also be fed into line 5 through line 7 and valve V1. A portion of the feed gas stream collected from the pressure swing adsorption unit D is fed through line 6 to a DEP recycle unit L and returned to the feed gas line 1 through line 6A for reentry into the feed compressor A.

In the thermal oxidizer F, hydrogen sulfide, water, carbon dioxide, non-methane organic compounds (NMOCs) and some methane are destroyed and the relatively benign gas stream is vented through line 8. Some of the oxidized components are fed through line 11 to a temperature swing adsorption heater J where they provide heat to the heater before being vented through line 12.

The methane that is recovered from the first pressure swing adsorption unit D is fed through line 8A to guard bed F. In the guard bed F, any additional impurities that may be present along with the methane are separated out. The methane now of greater purity is fed through line 9 to economizer K before entering the temperature swing adsorption unit H. The temperature swing adsorption unit H will separate methane from other impurities, notably carbon dioxide. The temperature swing adsorption unit H will contain adsorbent materials capable of separating these components. These adsorbent materials are typically mixed or in layered beds. The carbon dioxide that is separated will exit the temperature swing adsorption unit H through line 10 and through blower I will be fed back to the pressure swing adsorption unit D where the carbon dioxide will be used to purge the adsorbent bed during the purge and regeneration steps of the pressure swing adsorption cycle.

The methane is recovered from the temperature swing adsorption unit and fed through line 14 to economizer K where it will be fed to the liquefier feed (not shown) through line 15.

The waste gas stream from a gas separation column (not shown) is fed through line 13 through a temperature swing adsorption heater 13 where it will gain heat and be used during the purge and regeneration steps to purge the adsorbent materials in the temperature swing adsorption unit H.

Turning to FIG. 1b, there is described a fully integrated biogas/landfill gas purification system that uses two pressure swing adsorption beds in the system. The biogas/landfill gas feed stream is fed through line 20 to feed compressor M which provides the feed gas to an after-cooler N through line 21 and feed to a separator O where water condensate and other contaminants such as heavier VOCs, dust and particles are removed through line 22 from the feed gas stream.

The purified feed gas stream is fed from the separator O to the first pressure swing adsorption unit P. The pressure swing adsorption unit P contains an adsorbent or adsorbents that are capable of separating methane from other impurities present in the feed gas stream. These adsorbents can be for example, molecular sieves, Clinoptilites and aluminas which can be mixed or layered into individual beds. The contaminants separated from the methane leave the first pressure swing adsorption unit P through line 24 and aided by blower Q are fed into thermal oxidizer S. Air may also be fed to line 24 prior to the contaminants entry into the thermal oxidizer S. Some of the contaminants are withdrawn through line 26 and are fed through DEP recycle R back to the feed gas stream 20 prior to entering the feed compressor M.

In the thermal oxidizer S, impurities such as hydrogen sulfide, water, carbon dioxide, NMOCs with some methane are destroyed. The waste gas stream is vented through line 27. A portion of the waste gas stream is fed through line 28 to a waste heat trim heater U which will recover some heat from the waste gas stream before it is fed back into line 27 for venting.

The purified methane is fed through line 29 to guard bed T. In this guard bed, additional impurities that may still be present in the methane are separated out. The purified methane leaves the guard bed T through line 30 and passes through economizer Y where it will adsorb some heat. Line 30 further passes through the waste heat trim heater U where the purified methane will adsorb more heat before entering the second pressure swing adsorption unit V which will operate to separate out carbon dioxide present with the methane.

The second pressure swing adsorption unit V will contain adsorbent materials that are capable of separating methane from carbon dioxide plus any remaining impurities present with the methane. These adsorbents are mixed or in individual layered beds and comprise MG sieve or 13× zeolite sieve material. The separated impurities carbon dioxide, nitrogen, oxygen and some methane are fed through line 34 to vacuum pump W where they are fed back to the first pressure swing adsorption unit P to assist in purging the adsorbent bed during the purge and regeneration steps of the pressure swing adsorption cycle.

The methane that is separated is fed through line 33 to an economizer where it will be recovered as liquefied natural gas which may be stored or fed to other unit operations as a fuel stock. A portion of the methane recovered is fed through a DEP recycle compressor X through line 35 where it is fed to line 30 to increase the methane concentration of the stream containing methane and carbon dioxide that will enter the second pressure swing adsorption unit V.

A waste gas stream from a gas separation column (not shown) is fed through line 32 to the second pressure swing adsorption unit V where it will be used during the purge and regeneration steps to purge the adsorbent materials in the second pressure swing adsorption unit V. Landfill gas was purified and all water, sulfur compounds, NMOCs and carbon dioxide were removed by the pre-purification process shown in FIGS. 1a and 1b above. The purified gas stream that was fed to the liquefier contained primarily methane, nitrogen and oxygen and had the following composition in Table 1.

TABLE 1

| Specie | Mole Fraction | |
|---|---|---|
| Carbon dioxide | <50 | ppm |
| Nitrogen | 0.19 | |
| Methane | >0.79 | |
| Oxygen | <0.03 | |

In real world applications for liquefied natural gas the required purity is a maximum mole percentage of 4% for oxygen and nitrogen.

Three cases were considered. In the first, 21 metric tons per day of liquefied natural gas produced from landfill gas by purification to remove all NMOCs, water, sulfur compounds and carbon dioxide followed by cryogenic separation of the nitrogen and methane in an integrated distillation column with a reboiler and no condenser. The column operated at 15 psig (2.05 bar) and the liquefied natural gas was sent to storage at this pressure using a cryogenic pump.

In the second case, 21 metric tons per day of liquefied natural gas produced from landfill gas by purification to remove all NMOCs, water, sulfur compounds and carbon dioxide, as well as most inerts resulting in a feed gas stream that contains 96 mole % methane. This feed is liquefied in the main heat exchanger and sent to storage at a pressure of 3.08 bar. The results of the simulation as detailed are presented below in Table 2.

TABLE 2

| | Case 2 | Base case (Case 1) |
|---|---|---|
| LMTD, C | 4.86 | 4.69 |
| UA kJ/C-s | 358.80 | 368.13 |
| Hot Pinch, F. | −200.84 | −136.32 |
| Cold Pinch, F. | −203.65 | −140.49 |
| Min Approach, C | 1.56 | 2.32 |
| Exchanger Cold duty, kW | 1745 | 1726 |
| LNG temp, C. | −156.25 | |
| Compressor power, kW | 490 | 493 |
| Methane Recovery, % | 91.82 | |
| Column pressure, psig | 15 | 14.3 |
| LNG production, tpd | 21.0 | 21.0 |

Both the heat exchanger area and the liquefaction power are similar for the two cases. The methane produced in case 2 is 91.82% purity which is acceptable for the production of liquefied natural gas from biogas. The waste gas is used for regeneration of the cleanup PSA/TSA and is eventually flared or used to generate power in an engine or turbine.

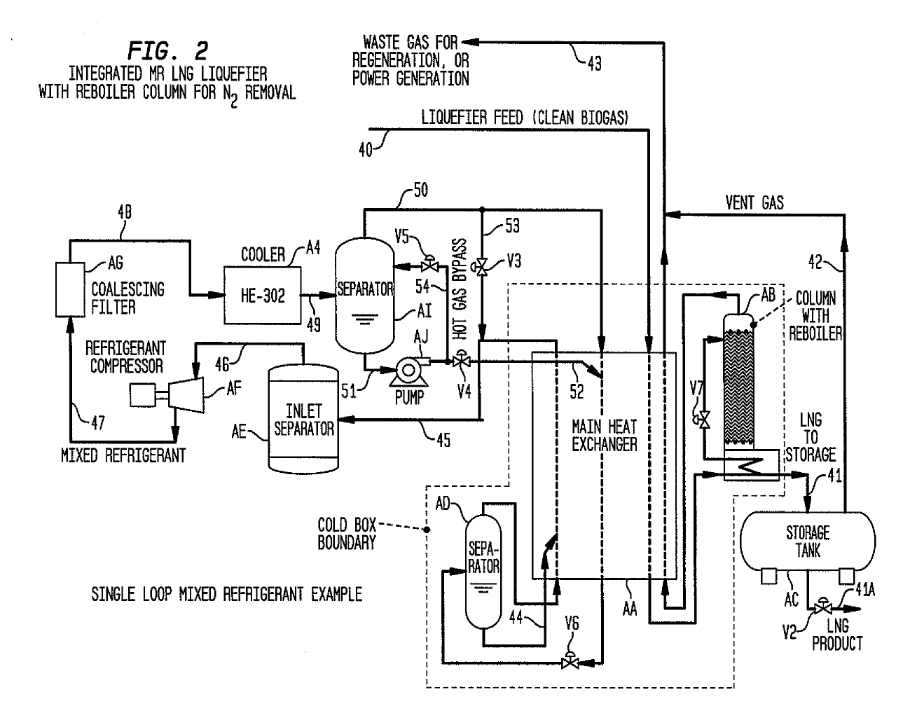

FIG. 2 is a schematic of an integrated mixed refrigerant liquefied natural gas liquefier with a reboiler column for nitrogen removal. Clean biogas as liquefier feed is fed through line 40 where it passes through the main heat exchanger AA. The warmer biogas will contact enter through open valve V7 a distillation column with reboiler AB where it will be subjected to distillation. The natural gas is recovered through the bottom of the column and heat exchanger through line 41 where it will be fed to a storage tank AC. The stored liquefied natural gas may be recovered through open valve V2 and line 41A.

Some of the liquefied natural gas is vented from storage tank AC through line 42 as natural gas. This vented natural gas will join with the gas stream coming off the top of the distillation column with reboiler AB. This waste gas stream is primarily nitrogen and is fed through the main heat exchanger AA to exchange its colder temperature before being recovered as a waste gas steam for regeneration of adsorption beds or for use in power generation.

A separator AD provides mixed refrigerant to the main heat exchanger AA through line 44 where is will be cooled and fed through line 45 to inlet separator AE. The inlet separator separates the eventual mixed refrigerant liquid residual from cold box outlet to avoid liquid at compressor suction and feeds through line 46 to a refrigerant compressor AF. The resulting mixed refrigerant is fed through line 47 to a coalescing filter AG where assist in oil droplet removal from the mixed refrigerant. The mixed refrigerant free of the oil droplets is fed through line 48 to a cooler AH where the cooled mixed refrigerant is fed through line 49 to a separator AI. The bottoms from the separator AI are fed through line 4541 and open valve V4 through a pump AJ and line 52 where it will join line 50 in the main heat exchanger AA. A portion of the bottoms is fed through line 54 and open valve V5 back to the separator AI.

The tops from the separator AI are fed through line 50 back through the main heat exchanger AA. A line 53 and open valve V3 will bypass a portion of the hot gas back to line 45t before entering inlet separator AE. Line 50 which contains the nitrogen from the top of separator AI will collect heat from the main heat exchanger AA and after passing through open valve V6 enter separator AD before entering the main heat exchanger AA through line 44 to cool down.

A heat and mass balance simulation was performed according to the method described for FIG. 2 for an integrated nitrogen recovery unit and distillation versus just a nitrogen recovery unit. Table 3 below shows a greater recovery of methane using less energy for the inventive method.

TABLE 3

| | NRU | distillation | change |
|---|---|---|---|
| methane recovery | 83% | 90% | +8.4% |
| specific consumption (kW/kg | 0.63 | 0.58 | −8.6% |
| LNG) | | | |

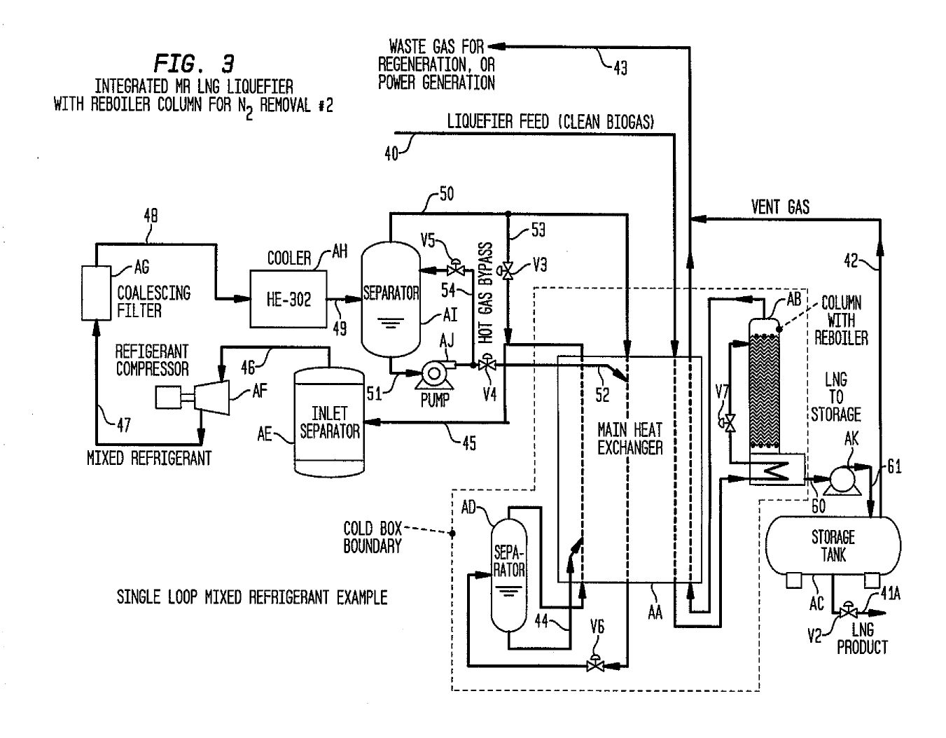

In FIG. 3, the same legends and numbers are used as were used to describe FIG. 2 except for the inclusion of a pump between the distillation column with reboiler AB and storage tank AC. The pump AK is employed to assist removing liquefied natural gas from the bottom of the distillation column with reboiler AB through line 60 and directing through line 61 the liquefied natural gas into the storage tank AC.

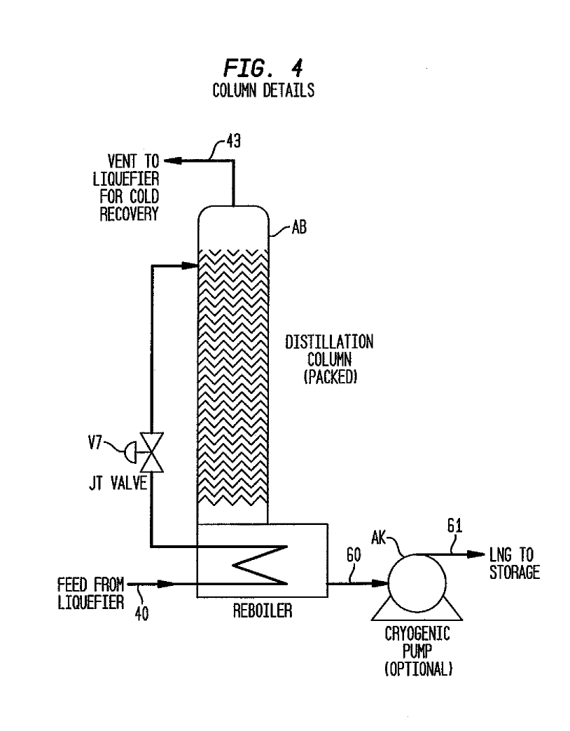

FIG. 4 describes in greater detail the distillation column with reboiler as detailed in FIGS. 2 and 3. The numbering system as used for FIG. 3 is also employed in describing FIG. 4. The packed distillation column with reboiler AB receives the biogas or landfill gas from a liquefier (not shown) through line 40. This feed gas stream will pass some heat to the reboiler portion of the distillation column and reboiler AB before passing through a Joule-Thomson valve and entering the top of the packed distillation column and reboiler AB.

The distillation column and reboiler AB is packed with the appropriate packing or plates to separate nitrogen from the methane. The nitrogen gas will be vented from the top of the packed distillation column and reboiler AB through line 43 and fed back to the main heat exchanger AA referred to in FIG. 3 to provide some cold to the main heat exchanger AA. The liquefied natural gas is recovered through the reboiler portion of the distillation column and reboiler through line 60 and optional cryogenic pump AK to line 61 for delivery to the storage tank AC as depicted in the description of FIG. 3.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for purifying a methane-containing gas comprising the steps of:
a) feeding a feedstream of methane-containing gas to a first pressure swing adsorption unit to remove contaminants from said methane-containing gas;
b) feeding said methane-containing gas to a guard bed wherein further contaminants are removed from said methane-containing gas;
c) feeding said methane-containing gas to a temperature swing adsorption unit to remove carbon dioxide; and
d) recovering purified methane-containing gas.

2. The method as claimed in claim 1 wherein said methane-containing gas is selected from the group consisting of biogas and landfill gas.

3. The method as claimed in claim 1 where said methane-containing gas is compressed prior to feeding to said pressure swing adsorption unit.

4. The method as claimed in claim 1 wherein said pressure swing adsorption unit contains adsorbents to remove contaminants from said methane-containing gas.

5. The method as claimed in claim 1 wherein said methane-containing gas is first fed to a separator to removed condensates and particles.

6. The method as claimed in claim 1 wherein said contaminants removed by said pressure swing adsorption unit are selected from the group consisting of hydrogen sulfide, water, non-methane organic compounds and carbon dioxide.

7. The method as claimed in claim 6 wherein said contaminants are destroyed by a thermal oxidizer.

8. The method as claimed in claim 1 wherein a portion of methane-containing gas recovered from said pressure swing adsorption unit is fed back to a line feeding methane-containing gas into said pressure swing adsorption unit.

9. The method as claimed in claim 1 wherein a portion of said methane-containing gas being fed to said pressure swing adsorption unit is diverted to a feed entering said thermal oxidizer.

10. The method as claimed in claim 1 wherein said guard bed separates other contaminants selected from the group consisting of halogenated compounds; volatile sulfur compounds; volatile oxygenates; aromatic hydrocarbons; volatile hydrocarbons, siloxanes and mercury from said methane-containing gas.

11. The method as claimed in claim 1 wherein a portion of said separated carbon dioxide is fed to said pressure swing adsorption unit to purge adsorbent beds in said pressure swing adsorption unit.

12. The method as claimed in claim 1 wherein nitrogen from a distillation column is used to purge adsorbent beds in said temperature swing adsorption unit.

13. The method as claimed in claim 1 wherein vent gas from said thermal oxidizer provides heat to said nitrogen used to purge adsorbent beds.

14. A method for purifying a methane-containing gas comprising the steps of:
a) feeding a feedstream of methane-containing gas to a first pressure swing adsorption unit to remove contaminants from said methane-containing gas;
b) feeding said methane-containing gas to a guard bed wherein further contaminants are removed from said methane-containing gas;
c) feeding said methane-containing gas to a second pressure swing adsorption unit to remove carbon dioxide; and
d) recovering purified methane-containing gas.

15. The method as claimed in claim 14 wherein said methane-containing gas is selected from the group consisting of biogas and landfill gas.

16. The method as claimed in claim 14 where said methane-containing gas is compressed prior to feeding to said pressure swing adsorption unit.

17. The method as claimed in claim 14 wherein said first pressure swing adsorption unit contains adsorbents to remove contaminants from said methane-containing gas.

18. The method as claimed in claim 14 wherein said methane-containing gas is first fed to a separator to removed condensates and particles.

19. The method as claimed in claim 14 wherein said contaminants removed by said pressure swing adsorption unit are selected from the group consisting of hydrogen sulfide, water, non-methane organic compounds and carbon dioxide.

20. The method as claimed in claim 19 wherein said contaminants are destroyed by a thermal oxidizer.

21. The method as claimed in claim 14 wherein a portion of methane-containing gas recovered from said first pressure swing adsorption unit is fed back to a line feeding methane-containing gas into said pressure swing adsorption unit.

22. The method as claimed in claim 14 wherein a portion of said methane-containing gas being fed to said first pressure swing adsorption unit is diverted to a feed entering said thermal oxidizer.

23. The method as claimed in claim 14 wherein said guard bed separates other contaminants selected from the group consisting of halogenated compounds; volatile sulfur compounds; volatile oxygenates; aromatic hydrocarbons; volatile hydrocarbons, siloxanes and mercury from said methane-containing gas.

24. The method as claimed in claim 14 wherein a portion of said separated carbon dioxide from said second pressure swing adsorption unit is fed to said first pressure swing adsorption unit to purge adsorbent beds in said first pressure swing adsorption unit.

25. The method as claimed in claim 14 wherein said second pressure swing adsorption unit contain adsorbents to remove carbon dioxide from said methane-containing gas.

26. The method as claimed in claim 14 wherein nitrogen from a distillation column is used to purge adsorbent beds in said second pressure swing adsorption unit.

27. The method as claimed in claim 14 wherein vent gas from said thermal oxidizer provides heat to said methane-containing gas being fed to said second pressure swing adsorption unit.

28. A method for producing liquefied natural gas comprising the steps of:
a) feeding a methane-containing gas stream to a heat exchanger, wherein the methane-containing gas stream will be cooled by the heat exchanger;
b) feeding the methane-containing gas to the reboiler of a distillation column, wherein the distillation column can be packed or contain sieve trays;
c) removing methane from the bottom of the packed distillation column as liquefied natural gas;
d) collecting nitrogen from the top of the packed distillation column and feeding the nitrogen through the heat exchanger and recovering cold;
e) purifying the nitrogen; and
f) feeding said purified nitrogen through said heat exchanger.

29. The method as claimed in claim 28 wherein said methane-containing gas stream is selected from the group consisting of biogas and landfill gas.

30. The method as claimed in claim 28 wherein said nitrogen is fed from said heat exchanger to a separator.

31. The method as claimed in claim 28 wherein said separator feeds said nitrogen back through said heat exchanger.

32. The method as claimed in claim 28 wherein said purifying comprises passing said nitrogen through at least one separator.

33. The method as claimed in claim 28 wherein said purifying further comprises a step of compressing and coalescing said nitrogen.

34. The method as claimed in claim 28 wherein said purifying nitrogen provides cold to said heat exchanger.

35. The method as claimed in claim 28 wherein said purifying nitrogen comprises the steps of feeding nitrogen from said heat exchanger to a first separator; feeding said nitrogen to an inlet separator; feeding said nitrogen to a refrigerant compressor, wherein a mixed refrigerant is formed; feeding said mixed refrigerant to a coalescing filter; feeding said mixed refrigerant to a cooler; feeding said mixed refrigerant to a second separator wherein nitrogen is separated and fed through said heat exchanger to said first separator.

36. The method as claimed in claim 28 wherein said methane-containing gas is at a pressure of 6 to 15 bar.

37. The method as claimed in claim 28 wherein the cooled methane-containing gas of step a) is at a temperature of about −145° C.
